(19) United States
(12) Patent Application Publication
(10) Pub. No.: US 2025/0305549 A1
(43) Pub. Date: Oct. 2, 2025

(54) BRAKE SHOE FOR SELF-CLAMPING RETENTION OF A UNIT THAT IS TRANSPORTABLE ON RAILS

(71) Applicant: Siemens Energy Global GmbH & Co. KG, München (DE)

(72) Inventors: Alexander Hackl, Marchtrenk (AT); Michael Bachl, Altenberg bei Linz (AT); Peter Dichlberger, Linz (AT)

(21) Appl. No.: 19/090,718

(22) Filed: Mar. 26, 2025

(30) Foreign Application Priority Data
Mar. 26, 2024 (DE) 10 2024 202 875.4

(51) Int. Cl. F16D 63/00; F16D 65/04; H01F 38/00

(52) U.S. Cl. CPC F16D 63/008; F16D 65/04; H01F 38/00

(57) ABSTRACT

A brake shoe that is lockable to a rail head of a rail for securing a unit transportable on rails, in particular a high-voltage device, such as a transformer. To maintain the position of the unit securely on a rail in a simple manner, the brake shoe is provided with a frame designed to clasp around at least portions of the rail head and at least one clamping element movably held in the frame. The brake shoe produces self-retaining clamping of the rail between the frame and the at least one clamping element.

### CROSS-REFERENCE TO RELATED APPLICATION

This application claims the priority, under 35 U.S.C. § 119, of German Patent Application DE 10 2024 202 875.4, filed Mar. 26, 2024; the prior application is herewith incorporated by reference in its entirety.

### FIELD AND BACKGROUND OF THE INVENTION

The invention relates to a brake shoe that is lockable to a rail head of a rail for securing a unit that is transportable on rails, in particular, a high-voltage device, such as a transformer.

Units such as transformers and other high-voltage devices, for example chokes, are moved in part by means of rollers on rails. To prevent the high-voltage device from shifting after final positioning, brake shoes are employed.

To achieve the necessary holding force, at least one clamp is placed on at least one of the rails and fixed by means of screws. The clamp is placed on the rail head, clasps around the same, and is fixed by the screws such that the clamp is pulled upwards. In this context, the clamp is pressed against the bottom side of the rail head. The holding force is dependent on the friction, especially in the longitudinal direction of the rail. The holding force is thus reduced by the friction factor between the clamp and the rail, since the clamping force is introduced perpendicularly to the holding force.

With increasing demand for earthquake fastenings, the requirements for brake shoes are also increasing, i.e., higher forces should be transmitted. In order to increase strength, there is an option to install a bolt projecting through the brake shoe and the rail. Thus, the holding force is no longer dependent on the friction factor, but on the strength of the bolt. Alternatively, the number of brake shoes may be increased.

All solutions in which the holding force is defined via the friction factor share the disadvantage that this factor cannot be determined exactly, and thus significant safety factors must be observed. Especially for earthquake anchoring, connections in which the holding force results via a friction factor are only permitted in a few cases. The bolted solution again has the disadvantage that a hole must be drilled into the rail, which is not readily or easily possible.

The known variants for increasing the holding force are thus complex or, as in the embodiment with the bolt, are associated with permanent damage to the rail.

### SUMMARY OF THE INVENTION

It is accordingly an object of the invention to provide a device which overcomes at least some of the above-mentioned and other disadvantages of the heretofore-known devices and methods of this general type and which provides for a brake shoe that may be mounted on the rail easily and/or non-destructively without any damage.

With the above and other objects in view there is provided, in accordance with the invention, a brake shoe that is lockable to a rail head of a rail for securing a unit that is transportable on rails, in particular, a high-voltage device such as a transformer. The brake shoe comprises:
a frame configured to clasp around at least a portion of the rail head;
at least one clamping element movably held in said frame;
said frame and said at least one clamping element being configured to produce a self-retaining clamping of the rail between said frame and said at least one clamping element.

In other words, the objects of the invention are achieved with a brake shoe that comprises a frame designed to clasp around at least portions of the rail head and at least one clamping element movably held in the frame, wherein the brake shoe is designed to produce self-retaining clamping of the rail between the frame and the at least one clamping element.

On the one hand, the self-retention enables the brake shoe to be fastened to the rail in a non-destructive manner. On the other hand, movement of the brake shoe relative to the clamping element in the direction in which the self-retention acts may lead to an increase in the holding force. Thereby, effective securing of the unit to the rail may be achieved.

In the following, for the sake of simplicity, a high-voltage device, in particular a transformer, is always mentioned as a unit transportable on rails.

However, the unit is not limited to high-voltage devices, but may instead be an object which is de-energized during operation or is not at all related to the field of high-voltage technology. In principle, the brake shoe according to the invention is also employable for passenger or freight cars or other rail vehicles.

The invention also relates to a unit transportable on rails, in particular a high-voltage device, preferably a transformer, wherein the unit is provided with at least one brake shoe according to the invention.

The solution according to the invention may be further improved by various embodiments which are each separately advantageous and combinable with one another at will. Those designs and the advantages related therewith are detailed in the following.

According to a first advantageous design of the brake shoe, the at least one clamping element may be movably held on the rail in a state of the brake shoe mounted on the rail and may be designed to be movable along the rail into a clamping position in which the clamping element clamps the frame to the rail. In the clamping position of the at least one clamping element, a sufficiently high holding force may already be produced to fix the brake shoe to the rail. Typically, the direction along the rail in which the clamping element is movably held is not exactly parallel to the rail. This is detailed further below.

Preferably, the clamping element is biasable in the direction in which the self-retention acts. If the biasing force acts in the same direction as the holding force needed, then the effect of self-retention may be utilized in a simple manner, such as, for example, in a clamping buckle of a belt. The holding force is then adjustable via the bias independently of the friction factor.

The holding force may be increased beyond the bias by selecting the coefficient of friction between the clamping element and the rail to be different from the coefficient of friction between the clamping element and the frame. This may be accomplished by the selection of the material, the nature of the surface, the introduction of corresponding coverings, or by other measures.

The at least one clamping element is preferentially movably held in at least one guide in the frame, the guide being inclined with respect to the rail, in particular inclined upwards, in a state of the brake shoe mounted on the rail. The holding force is thus independent of the friction factor. The holding force is then dependent, analogously to a wedge, on the angle between the guide and the rail.

In a state of the brake shoe mounted on the rail, the clamping element preferably rests against a top side of the rail, that is, on the rail head. Movement of the clamping element in the inclined guide towards the rail thus leads to lifting the frame.

Since the frame clasps around the rail head, in particular with a clasping portion, the frame is pulled upwards during this movement, and the clasping portion is pressed against the bottom side of the rail head. If the frame were to be moved along the rail in the opposite direction, for example during movement of the high-voltage device, the clamping element would pull the frame more strongly upwards until the holding force is so great that a movement of the frame relative to the rail is no longer possible.

The at least one guide preferably comprises one, in particular rectilinear, slot in the frame. The at least one clamping element projects through the slot. In this context, a slot height and a diameter of the clamping element are preferentially adapted for one another so that the clamping element has just sufficient clearance to be movable along the slot.

The clamping element may have a polygonal, preferably a rectangular, particularly preferably a square cross-section. Alternatively, the cross-section of the clamping element may have the shape of a trapezoid or a parallelogram or may even be round. At least one, preferentially planar, side thereof may rest against an inner wall in the frame delimiting the slot. Thereby, the clamping element may also be secured against twisting.

A particularly stable arrangement may be obtained by the frame having two guides for the at least one clamping element opposing one another across the rail in a state of the brake shoe mounted on the rail. The two guides are preferentially arranged parallel to one another. The clamping element is then orientated transversely to the rail and is held within the guides by both sides of the rail.

According to a further advantageous design of the brake shoe according to the invention, at least one biasing element is provided, which is designed to move the at least one clamping element into the clamping position. Thereby, a bias may be produced. The biasing element may in particular be a threaded bolt arranged to interact with an internal thread in the clamping element. Rotation of the bolt may lead to displacement of the clamping element.

As described above, a single clamping element acts in only one direction along the rail. To produce self-retention in the opposite direction as well, the high-voltage device may be provided with two brake shoes according to the invention, the frames and clamping elements of which are designed to produce self-retentions acting in opposite directions.

Alternatively, a brake shoe may be provided which is designed for self-retention in two opposite directions along the rail. This variant described in the following is preferred over the above-mentioned variant with one brake shoe each for one direction.

To produce self-retention in two opposite directions along the rail on a brake shoe, the brake shoe is preferably provided to have two clamping elements designed for self-retention of the brake shoe on the rail in opposite directions.

In this context, each clamping element is preferentially received in its own guide, the two guides being oriented in a mirror-symmetric manner with respect to one another.

To obtain a frame with a simple structure, the two guides may comprise a common slot. The common slot may combine the two individual slots of the individual guides. Since the two individual slots are inclined with respect to the rail in different orientations, the common slot may have an angled shape, in particular a roof shape.

To be able to provide both clamping elements with a bias, a common biasing element is preferably provided, which is designed to move the two clamping elements into their respective clamping positions.

In particular, the common biasing element may be designed to drive the two clamping elements apart. The at least one common biasing element is preferentially a threaded bolt. Each clamping element may have a corresponding internal thread. The threaded bolt and the internal threads of the clamping element are preferentially adapted for one another so that rotation of the bolt leads to the clamping elements being moved either towards one another or away from one another. This may be realized using corresponding right/left threads. According to the orientation of the guides, one of the movements may lead to the bias of the two clamping elements being produced.

Preferably, the guides are arranged such that the bias is produced when the clamping elements are pushed apart by the bolt. If a bias is applied to the clamping elements by rotation of the bolt, they move outwards, pull the frame upwards, and clamp it to the rail. The holding force then results only from the biasing force and no longer from the friction factor.

For further explanation of the invention, reference is made in the following part of the description to figures from which further advantageous details and possible fields of application of the invention may be derived. The figures are to be understood as exemplary and are intended to illustrate the character of the invention, but not to restrict it in any way or even to recite it exhaustively. The same reference numerals are always used for elements having the same structure and/or the same function.

Other features which are considered as characteristic for the invention are set forth in the appended claims.

Although the invention is illustrated and described herein as embodied in a brake shoe for self-retaining securing of a unit transportable on rails, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a perspective cutaway view of a preferred embodiment of a brake shoe according to the invention on a rail;

FIG. 2 shows a section through the brake shoe of FIG. 1 taken along the line I-I in FIG. 1,

FIG. 3 is a schematic depiction of an advantageous embodiment of clamping elements for the brake shoe of FIGS. 1 and 2;

FIG. 4 shows a schematic depiction of a biasing element for the brake shoe of FIGS. 1 to 3; and

FIGS. 5-8 show schematic depictions of further embodiments of brake shoes according to the invention.

### DETAILED DESCRIPTION OF THE INVENTION

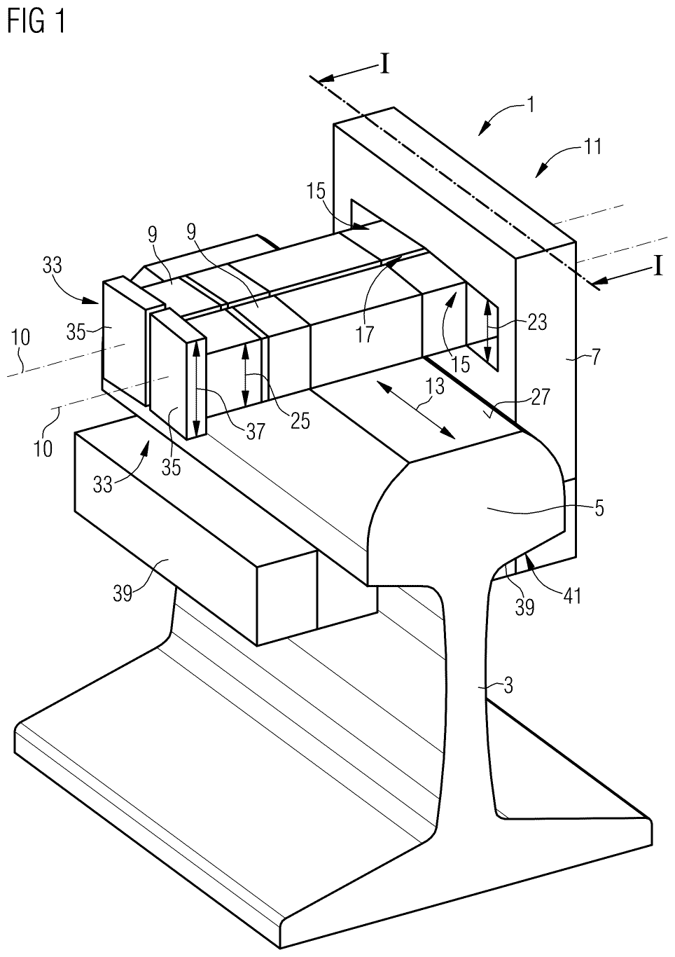

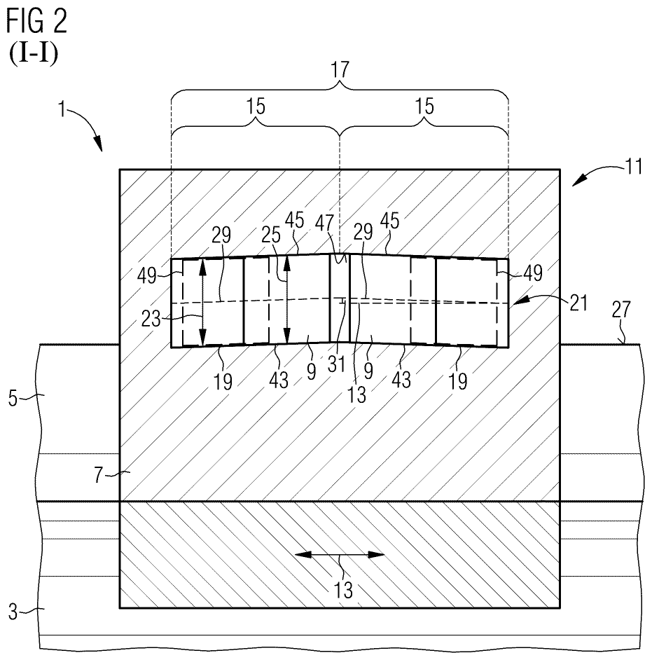

In the following, a preferred embodiment of a brake shoe 1 according to the invention is described with reference to FIGS. 1 and 2. For better understanding, the brake shoe 1 is depicted on a section of a rail 3.

For the sake of better clarity, part of the brake shoe 1 is not depicted. A unit such as a high-voltage device, which is transportable on the rail 3, is also not depicted. In the following, a high-voltage device, which is preferentially a transformer, is always mentioned as an example of the unit.

The high-voltage device preferably has at least one brake shoe 1 connected to the high-voltage device in a captive manner. Typically, the high-voltage device is transported on a pair of rails. However, the second rail as well as the wheels with which the high-voltage device may be moved on the rails are also not shown for the sake of visibility.

The brake shoe 1 is lockable to a rail head 5 of the rail 3. With this, the high-voltage device that is connected to the brake shoe 1 may be secured to the rail 3.

The brake shoe 1 comprises a frame 7 designed to clasp around portions of the rail head and two clamping elements 9 movably held in the frame 7.

The brake shoe 1 is designed to produce self-retaining clamping of the rail 3 between the frame 7 and the clamping element 9.

In a state 11 of the brake shoe 1 mounted on the rail 3, the clamping elements 9 may be moved along a longitudinal direction 13 of the rail 3.

Each clamping element 9 is movably held in two guides 15 opposing one another across the rail 3 in the state 11 mounted on the rail. In FIG. 1, one guide 15 each per clamping element 9 is depicted on only one side of the rail 3.

The guides 15 on one side of the rail merge into one another and form a common guide 17.

Each of the guides 15 comprises a slot 19 extending through the frame 7. The two slots 19 on one side of the rail 3 form a continuous slot 21.

Preferably, each clamping element 9 has an overall elongated shape and extends along a longitudinal axis 10.

Each clamping element 9 extends through the two slots 15 opposing one another across the rail 3, with its longitudinal axis 10 extending perpendicularly to the longitudinal direction 13 of the rail 3.

At least in the region in which the clamping elements 9 penetrate the slots 19 and extend across the rail 3, they have a rectangular, preferably a square or even round cross-section.

Each slot 19 has a slot height 23 and each clamping element 9 has a diameter 25. The slot height 23 and the diameter 25 are adapted for one another so that the clamping elements 9 are movable in the slots 19 along the longitudinal direction 13, but cannot twist, in particular not about their longitudinal axes 10.

Each guide 15 or each slot 19, respectively, is inclined with respect to the longitudinal direction 13, in particular inclined with respect to a top side 27 of the rail head 5. That is, each slot 19 has a slope.

On the right-hand side of FIG. 2, a slot direction 29 is depicted in comparison with the longitudinal direction 13 of the rail 3 indicated by dashed lines. The two directions enclose the angle 31.

The continuous slot 21 overall has a roof shape, since the two slots 19 extend away from one another and simultaneously downwards, forming the angle 31. The two slots 19 or the two guides 15, respectively, are arranged mirror-symmetrically with respect to one another. As an alternative to the roof shape, the continuous slot 21 may have other shapes, in particular a V-shape.

To prevent any loss or jamming of the clamping elements 9, their ends 33 projecting outwards from the frame 7 are provided with, in particular flange-like, blocking elements 35, the diameters 37 of which are in each case greater than the slot height 23. The blocking elements 35 may be plate-shaped.

In the state 11 mounted on the rail 3, the frame 7 has a clasping portion 39 on each side of the rail 3, which is designed to rest against a bottom side 41 of the rail head 5.

In the following, the function of the brake shoe 1 described above with reference to FIGS. 1 and 2 is explained.

Before the brake shoe 1 is locked to the rail 3 by the clamping elements 9, the clamping elements 9 may be located close to one another, as depicted in FIGS. 1 and 2.

Since the guides 15 are inclined, the clamping elements 9 are arranged in upper regions of the guides 15. Preferentially, in this context, the clamping elements 9 rest on the rail head 5, with a lower flat side 43 thereof resting flat against the top side 27 of the rail head 5.

Each clamping element 9 has an upper flat side 45 opposing the lower flat side 43. An upper enclosure 47 of the slot 21 rests against those upper flat sides 45.

In alternative embodiments, the clamping elements 9 may have different shapes instead of having flat sides 43, 45. For example, the clamping elements 9 may have round or polygonal cross-sections.

If the clamping elements 9 are now moved away from one another, they move downwards with respect to the guides 15. However, since they rest on the rail 3 and the rail 3 prevents a downward movement of the clamping elements, the frame 7 is pulled upwards instead. In this context, the clasping portion 39 of the frame 7 is pressed against the bottom side 41 of the rail head 5 and hence produces a holding force between the brake shoe 1 and the rail 3. If sufficient holding force is produced, the clamping elements 9 are located in clamping positions 49 indicated by dashed lines in FIG. 2.

If a force were now to act on the brake shoe 1 along a direction parallel to the rail 3, which moves the brake shoe 1 along the rail 3, one of the clamping elements 9 could be released from its clamping position 49.

However, the respective other clamping element 9 would be moved in the opposite direction in the slot 21 and would pull the frame 7 further upwards. This would increase the holding force and would prevent any movement of the brake shoe 1 and the high-voltage device connected thereto.

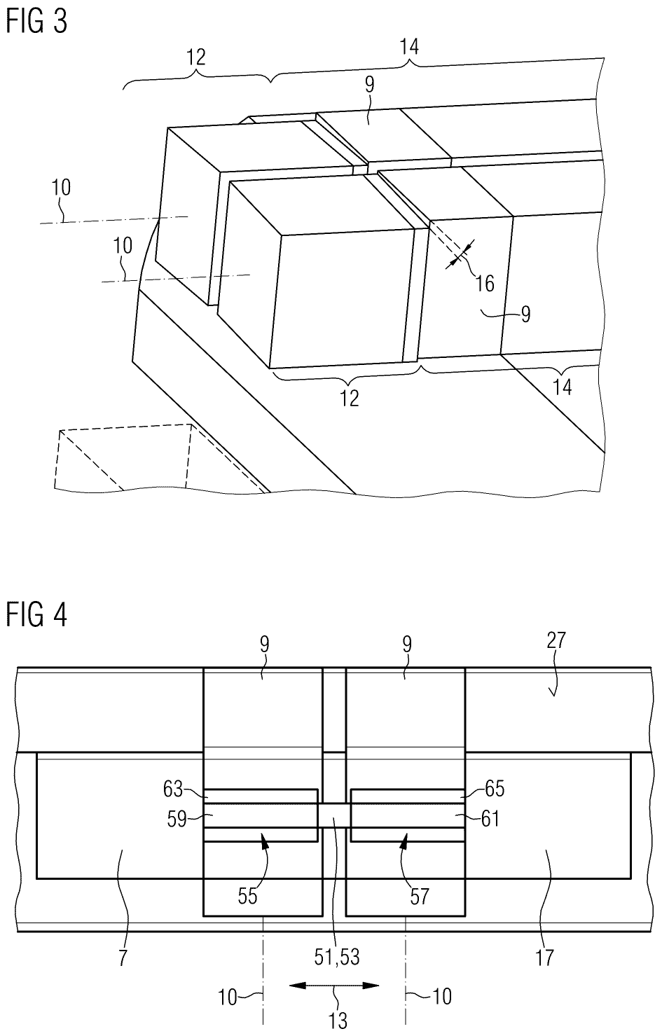

FIG. 3 shows a preferred embodiment of the clamping elements 9. In this embodiment, end portions 12 of the clamping elements 9 are each rotated about the longitudinal axes 10 by an angle 16 relative to the remaining portions 14. In this context, the end portions 12 of the clamping elements 9 are each rotated in opposite directions.

The angles 16 preferentially correspond to the angles 31 enclosed between the slot direction 29 and the longitudinal direction 13. Thereby, the clamping elements 9 may rest flat against the inner sides of the slots 9 in the end portions 12 and may rest flat on the top side 27 of the rail head 5 in the remaining portions 14.

In alternative embodiments, not depicted, of the clamping element 9, for example round or polygonal ones, other resting shapes and angles result.

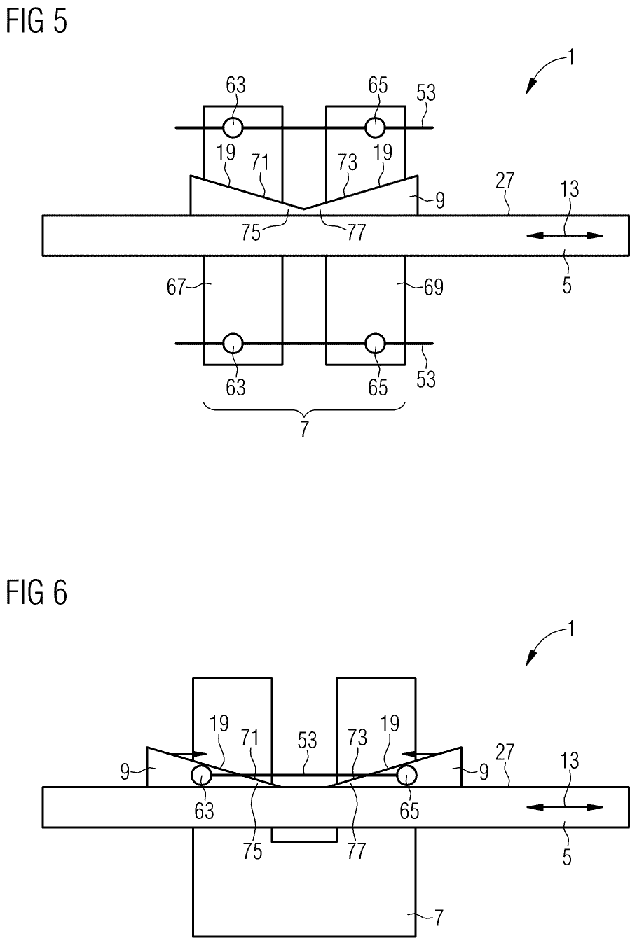

To sufficiently bias the clamping elements 9 towards their clamping positions 49 and to prevent the departure from the clamping positions 49 described above, at least one biasing element 51 may be provided. This biasing element 51 is detailed in the following with reference to FIG. 4.

The biasing element 51 is preferentially a bolt 53 having at its ends 55, 57 one external thread 59, 61 each, wherein

Each clamping element 9 is provided with an internal thread 63, 65. The two internal threads 63, 65 are designed to match the external threads 59, 61 in a contra-rotating manner.

Rotation of the bolt 53 leads to simultaneous movement of the two clamping elements 9. According to the direction of rotation of the bolt 53, the clamping elements 9 are moved away from one another or towards one another.

If the two clamping elements 9 are moved away from one another, they may be biased, and the desired holding force may thereby be adjusted. Moreover, the cooperation of the clamping elements 9 with the bolt 53 may prevent any undesired movement of the clamping elements 9 out of the clamping position 49.

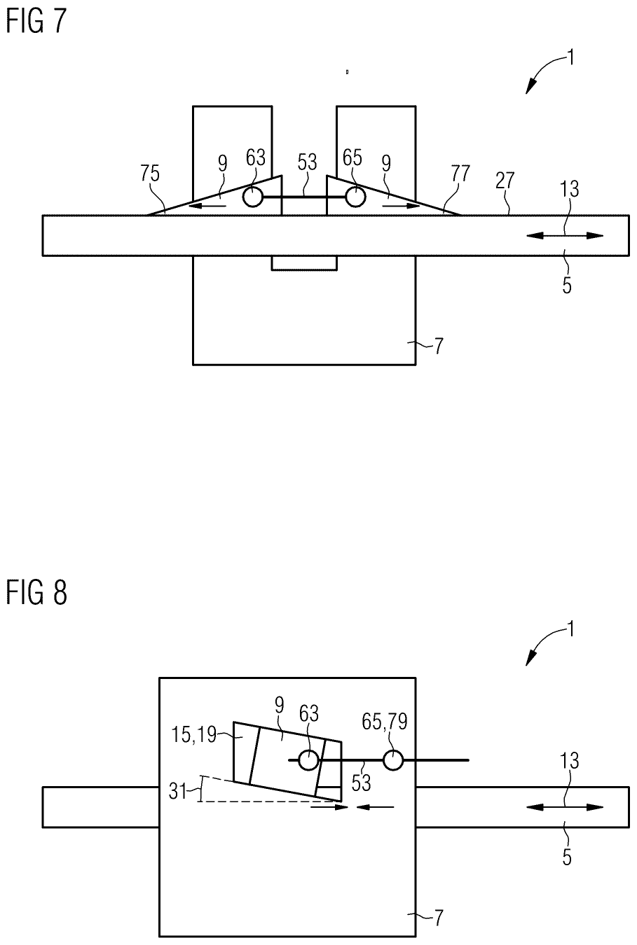

In the following, further advantageous ways of establishing self-retention on embodiments of the brake shoe 1 according to the invention are described with reference to FIGS. 5 to 8.

In this context, FIGS. 5 to 8 are merely schematic depictions intended to explain the respective functionality. For the sake of brevity, only the differences with respect to the embodiments described above are detailed in each case.

FIG. 5 shows an embodiment of the brake shoe 1 in which, in contrast with the embodiment depicted above, the frame 7 is of two-part design and the clamping element 9 is of one-part design.

The frame consists of the two frame parts 67 and 69 displaceable against one another along the rail direction 13.

The clamping element 9 has two inclinations 71 and 73 orientated in an opposing manner, so that the cross-section of the clamping element 9 has the shape of two wedges, with the tips 75, 77 thereof resting against one another.

Each of the frame parts 67, 69 is provided with a slot 19 in which one half of the clamping element 9 is received.

If the frame parts 67, 69 are moved away from one another parallel to the rail direction 13, they slide up the inclinations 71, 73, so that clamping is produced between the frame parts 67, 69 and the rail head 5.

At least one bolt 53, preferentially a plurality of bolts 53, may be provided for moving the two frame parts 67, 69 against one another.

As in the embodiment described with reference to FIGS. 1 to 4, the bolt 53 may be provided with two contra-rotating external threads (not shown in FIG. 5).

Each frame part 67, 69 may be provided with a matching internal thread 63, 65 for each bolt 53, with which the bolt 53 may cooperate. According to the direction of rotation, rotation of the bolt 53 leads to movement of the frame parts 67, 69 towards one another or away from one another.

FIG. 6 depicts an embodiment of the brake shoe 1 in which the slots 19 are formed in the same frame 7, as in the embodiment depicted with reference to FIGS. 1 to 4.

The two clamping elements 9 each have a wedge shape, with each clamping element 9 having an inclination 71, 73. The inclinations 71, 73 are similar to the inclinations of the embodiment described with reference to FIG. 5.

The tips 75, 77 of the wedge shapes are arranged facing one another. Slots 19 in the frame 7 are shaped corresponding to the inclinations 71, 73.

At least one bolt 53 connects the two clamping elements 9 to one another, each of the clamping elements 9 being provided with an internal thread 63, 65 cooperating with the respective external thread of the bolt 53.

Rotation of the bolt 53 causes relative movement of the clamping elements 9 against one another. To establish the clamping connection between the frame 7 and the rail head 5, the wedge-shaped clamping elements 9 are moved towards one another. This is indicated by the arrows in FIG. 6.

The embodiment of the brake shoe 1 depicted in FIG. 7 corresponds to the embodiment of FIG. 6, with the wedge-shaped clamping elements 9 being arranged with their tips 75, 77 facing away from one another. The slots 19 are adapted to match the shape of the clamping elements 9.

For establishing the clamping connection between the frame 7 and the rail head 5, the two clamping elements 9 are moved away from one another by rotation of the bolt 53. This is indicated in FIG. 7 by the two arrows.

The embodiment of the brake shoe 1 depicted in FIG. 8 corresponds substantially to the embodiment described with reference to FIG. 4, with the difference that only one clamping element 9 is provided.

For moving and securing the clamping element 9, it is connected to the frame 7 via the bolt 53.

At one end, the external thread of the bolt 53 is received in the internal thread 63 of the clamping element 9 and is functionally coupled thereto.

At its end facing away from the clamping element 9, the external thread of the bolt 53 is received in a through-hole 79 in the frame 7 and is preferentially functionally coupled to an internal thread 65 in the through-hole 79.

Rotation of the bolt 53 causes movement of the clamping element 9 in the slot 19 relative to the internal thread 65 arranged in the frame 7.

According to the orientation of the slot 19 in the frame 7 or of the angle 31, respectively, the clamping connection may be established by movement of the clamping element 9 towards or away from the through-hole 79 or the internal thread 65, respectively.

In the example depicted in FIG. 8, the clamping connection may be produced by movement of the clamping element 9 towards the through-hole 79 or towards the internal thread 65, respectively. This is indicated in FIG. 8 by the arrows.

The following is a summary list of reference numerals and the corresponding structure used in the above description of the invention:
1 Brake shoe
3 Rail
5 Rail head
7 Frame
9 Clamping element
10 Longitudinal axis
11 State mounted on the rail
12 End portion
13 Longitudinal direction of the rail
14 Portion
15 Guide
16 Angle
17 Common guide
19 Slot
21 Continuous slot
23 Slot width
25 Diameter of a clamping element
27 Top side of the rail head
29 Slot direction
31 Angle
33 Ends of the clamping element
35 Blocking element
37 Diameter of the blocking element
39 Clasping portion
41 Bottom side of the rail head
43 Lower flat side
45 Upper flat side
47 Enclosure of the continuous slot
49 Clamping position
51 Biasing element
53 Bolt
55,57 Ends
59,61 External thread
63,65 Internal thread
67,69 Frame part
71,73 Inclination
75,77 Wedge tip
79 Through-hole

1. A brake shoe that is lockable to a rail head of a rail, the brake shoe comprising:
a frame configured to clasp around at least a portion of the rail head;
at least one clamping element movably held in said frame;
said frame and said at least one clamping element being configured to produce a self-retaining clamping of the rail between said frame and said at least one clamping element.

2. The brake shoe according to claim 1, wherein, when said brake shoe is mounted on the rail, said at least one clamping element rests on a top side of the rail head, and a clasping portion of said frame rests against a bottom side of the rail head.

3. The brake shoe according to claim 1, wherein said frame is formed with at least one guide which is inclined with respect to the rail and wherein said at least one clamping element is movably held in said at least one guide in a state in which the brake shoe is mounted on the rail.

4. The brake shoe according to claim 3, wherein said guide comprises at least one slot in said frame through which said at least one clamping element projects.

5. The brake shoe according to claim 3, wherein said frame has two guides for said at least one clamping element opposing one another across the rail in a state when the brake shoe is mounted on the rail.

6. The brake shoe according to claim 1, which comprises at least one biasing element configured to move said at least one clamping element into a clamping position.

7. The brake shoe according to claim 1, which comprises two clamping elements configured for self-retention of the brake shoe on the rail in opposite directions.

8. The brake shoe according to claim 7, wherein each of said two clamping elements is received in a respective one of two guides formed in said frame, with said two guides being oriented mirror-symmetrically with respect to one another.

9. The brake shoe according to claim 8, wherein said two guides are embodied as a continuous slot for receiving said two clamping elements.

10. The brake shoe according to claim 7, which comprises a common biasing element configured to move said two clamping elements into their respective clamping positions.

11. The brake shoe according to claim 10, wherein said common biasing element is configured to drive said two clamping elements apart or to pull said two clamping elements together.

12. The brake shoe according to claim 3, wherein a coefficient of friction between said at least one clamping element and a top side of said rail head is greater than a coefficient of friction between said clamping element and said guide in said frame.

13. The brake shoe according to claim 1, wherein said frame and said at least one clamping element are configured to produce self-retaining clamping for securing a unit that is transportable on rails.

14. The brake shoe according to claim 13, wherein the brake shoe is configured to secure a transformer on the rail.

15. A combination, comprising:
a high-voltage device configured for transportation on rails; and
at least one brake shoe according to claim 1 for securing the high-voltage device to a rail.

16. The combination according to claim 15, wherein said high-voltage device is a transformer.
